(19) United States
(12) Patent Application Publication
(10) Pub. No.: US 2013/0037305 A1
(43) Pub. Date: Feb. 14, 2013

(54) ELECTRICAL CONDUCTOR COATED IN A BONDING LAYER, AND A METHOD OF MANUFACTURING SUCH AN ELECTRICAL CONDUCTOR

(71) Applicants: Jerome Fournier, Lyon (FR); Arnaud Piechaczyk, Lyon (FR); Olivier Pinto, Lyon (FR); Jean-Pierre Pascault, Villeurbanne (FR); Francoise Fenoullot, L'isle D'abeau (FR); Laurent Tribut, Dole (FR)

(72) Inventors: Jerome Fournier, Lyon (FR); Arnaud Piechaczyk, Lyon (FR); Olivier Pinto, Lyon (FR); Jean-Pierre Pascault, Villeurbanne (FR); Francoise Fenoullot, L'isle D'abeau (FR); Laurent Tribut, Dole (FR)

(21) Appl. No.: 10/557,102

(22) PCT Filed: May 14, 2004
(86) PCT No.: PCT/FR04/01183

§ 371 Date: Jan. 29, 2007

(30) Foreign Application Priority Data
May 16, 2003 (FR) 03/05928

(51) Int. Cl. H01B 7/40; B05D 3/06; B05D 5/12

(52) U.S. Cl. 174/120 C; 427/58; 427/558

(57) ABSTRACT

The invention relates to an electrical conductor coated in an insulating layer itself coated in a bonding layer, the conductor being characterized in that said bonding layer is obtained from a composition comprising a thermoplastics polymer and a settable resin. The invention also applies to a method of manufacturing such an electrical conductor coated in a bonding layer, the method being characterized in that it comprises applying said composition on said electrical conductor coated in said insulating layer, and applying treatment to cause said settable resin to be cured at least in part.

The present invention relates to an electrical conductor coated in a bonding layer, and also to a method of manufacturing such an electrical conductor.

In the manufacture of electric motors, as great a quantity of winding wire as possible is incorporated in the core of the stator.

Magnet wire, also known as enameled wire, for use in electric motors, or indeed in electromagnetic deflector coils for television, is typically constituted by a thin electric wire, often made of copper, coated in one or more insulating layers of small thickness.

In order to obtain the desired electrical, thermal, and mechanical characteristics, one or more such insulating layers are constituted, for example of: polyurethane; polyvinyl acetal formal; polyester; polyester imide; or polyamide imide; these families of materials having various temperature classes lying in the range 120° C. to 200° C. In order to hold a coil together, use is made of an outer layer of a self-bonding thermoplastic polymer, such as certain polyamides having a melting point of about 150° C. to 190° C. This self-bonding layer, i.e. a layer that becomes adhesive under the effect of heat, thus serves to bond the turns to one another and guarantees that the turns are held together as a solid unit. The self-bonding layer overlies the above-mentioned insulating layers.

Document U.S. Pat. No. 4,420,536 discloses an enameled wire in which the self-bonding layer is nylon 6-12.

To manufacture that type of coil, one or more layers of enameling varnish are initially applied to the wire and, after being baked, constitute insulating layers; thereafter, the self-bonding polymer is applied in solution and then the coil is wound. For bonding purposes, an electric current is applied to the coil while its turns are generally being held pressed against one another, and the current acts by the Joule effect to melt the self-bonding polymer. On cooling, the turns are touching and the assembly is both solid and protected.

Bonding can also be achieved by passing the coil through an oven, as proposed in document U.S. Pat. No. 4,420,536.

However, the above-described coil is not intended for applications involving high operating temperatures, e.g. for the rotors and the stators of a motor vehicle alternator, which reach or greatly exceed the melting temperature of the self-bonding polymer.

In order to obtain coils that withstand high temperatures, a different type of magnet wire is used. This is an electric wire that is initially coated in a conventional insulating layer and that is wound in that state, after which it is impregnated in an impregnating varnish based on a resin, e.g. an unsaturated polyester or an epoxy resin in a solvent. Subsequent heat treatment serves to drive out the solvent and harden the resin. That method of manufacture needs to be implemented by the user of the wire, and it is constraining, lengthy, difficult to implement, and harmful to the environment because of the solvent being dumped into the atmosphere.

The object of the invention is to mitigate those problems and more broadly to develop an electrical conductor that is coated in a bonding layer, that withstands high temperatures, and that can be obtained using a method that is simple so as to form a magnet wire, or a power cable, and/or a telecommunications cable.

Throughout the specification below, a plastics material is said to withstand high temperatures providing it is thermally stable, i.e. providing it maintains good mechanical properties, on being subjected to high temperatures, typically greater than 150° C., even over a long duration, e.g. after tens of thousands of hours.

To this end, invention provides an electrical conductor coated in an insulating layer, itself coated in a bonding layer, the conductor being characterized in that said bonding layer is obtained from a composition comprising a thermoplastic polymer and a settable resin.

The insulating layer should be understood as being electrically insulating.

The layer obtained from the composition of the invention withstands high temperatures: its molecular mobility is low even at high temperature, which is advantageous both in cable applications and in magnet wire applications.

The term “settable resin” is used to mean a plastics material which, on being processed, is subjected to an irreversible transformation: when a suitable setting treatment is applied thereto (the action of heat and/or of radiation of the ultraviolet type, reaction with a curing compound), it passes irreversibly from an initial state that is liquid to a solid state. Such setting treatment corresponds to polymerization and more particularly to cross-linking (thermo-cross-linking and/or photo-cross-linking). It results in forming a three-dimensional lattice.

On curing, the settable resin forms strong and irreversible chemical bonds giving the final layer excellent strength. The greater the degree of cross-linking, the better the thermal and mechanical properties of the final bonding layer.

The settable resin ensures that the bonding is irreversible, even at high temperature.

Preferably, the settable resin is photocurable or thermosettable.

The bonding layer of the invention may be said to be “self-bonding” when the selected resin is thermosettable and/or the thermoplastic polymer is self-bonding.

When the thermoplastic polymer is selected to be semicrystalline and the resin is thermosettable, direct or indirect heating for curing purposes leads to the thermoplastic softening and thus contributing to bonding.

In an advantageous embodiment, the thermoplastic polymer presents a glass transition temperature (Tg) greater than or equal to 150° C.

Glass transition is a reversible change in an amorphous polymer or in the amorphous portions of a semicrystalline polymer from (or to) the viscous state and to (or from) the hard and relatively fragile state.

Thus, an amorphous polymer remains rigid up to this high glass transition temperature Tg. In this way, a high glass transition temperature Tg also contributes to conferring satisfactory mechanical properties to the final bonding layer at high temperatures.

By way of example, mention can be made of polyetherimide (PEI) which is an amorphous polymer having a glass transition temperature Tg of about 220° C.

Preferably, when the thermoplastic polymer is semicrystalline, the thermoplastic polymer presents a melting temperature greater than or equal to 200° C.

By way of example, mention can be made of polyethylene terephthalate (PET) which is a semicrystalline polymer having a melting temperature of about 240° C.

According to an advantageous characteristic, the thermoplastic polymer is preferably at least partially soluble in the settable resin, thus making it possible to form a homogenous mixture prior to curing.

Furthermore, the thermoplastic polymer is preferably selected from one or more of the following polymers: polystyrenes; polyetheretherketones; polyetherimides; polyamides; polyolefins and copolymers of polyolefins; polysulfones; polyurethanes; polyesters; cyclic oligoesters; polyimides and copolymers of polyimides; polyphenylene ethers; polyphthalamides; vinyl polychlorides; polyacrylics; polymethacrylates; and polycarbonates.

The settable resin is selected from epoxy resins, vinyl ester resins, unsaturated polyester resins, phenolic resins, alkyl resins, acrylic resins, ester cyanates, and benzoxazines.

Amongst polyimides (PI) and copolymers of polyimides, mention can be made for example of polyetherimide (PEI), polyesterimide, and polyamideimide.

The polyester family includes in particular polyethylene terephthalate (PET) and polybutylene terephthalate (PBT).

Polyether sulfone (PES) and polyphenylene sulfone form part of the polysulfone family.

When the resin is thermosettable, its composition may include at least one of the following ingredients: a curing compound that is chemically reactive with said settable resin, and a curing catalyst, or both.

The thermosettable resin may be premixed with the setting compound, also know as a hardener, and optionally a curing catalyst.

The setting compound may also be the thermoplastic polymer.

In a preferred embodiment, the resin is thermosettable and is an epoxy homopolymer and preferably a diglycidyl ether of bisphenol-A, and the setting compound is selected from amine compounds, carboxylic anhydrides, and polyamides.

The composition of the invention may contain 30% to 60% parts by weight of polyphenylene oxide and 70% to 40% parts by weight of a mixture containing diglycidyl ether of bisphenol-A and an amine selected from 4,4′-methylenebis-(2,6-diethyl)benzenamine amine and 4,4′-methylenebis-(3-chloro-2,6-diethyl)benzenamine.

The settable resin may also be a settable resin selected from epoxy resins, vinyl ester resins, unsaturated polyester resins, phenolic resins, alkyl resins, acrylic resins, ester cyanates, and benzoxazines.

For example, urethane acrylates, polyester acrylates, or polyether acrylates can be photocurable acrylate resins.

When the resin is photocurable, the composition may include a photoinitiator and optionally a curing catalyst.

The electrical conductor coated in accordance with the invention may be a conductor of a power cable and/or a telecommunications cable, or an enameled magnet wire, for example.

The final bonding layer may act as a sheath and/or may provide insulation, depending on the application, however the electrical conductor of the invention always includes at least one underlying electrically insulating layer. If the self-bonding layer of the invention were to be deposited directly on the electrical conductor, then during heating for bonding purposes, the various turns would come into electrical contact with one another, and that is incompatible with an application to enameled wires.

However, an electrical conductor of the invention may include additional layers between the insulating layer and the self-bonding layer.

The invention also provides a method of manufacturing an electrical conductor coated in a bonding layer, the method being characterized in that it comprises applying the above-defined composition on said conductor and treating said settable resin to cause it to be cured, at least in part.

The composition is applied by injecting or extruding the composition of the invention, for example. The settable resin makes it possible to use a thermoplastic with a high glass transition temperature.

In addition, a thermosettable resin is very liquid and on its own does not remain on a conductor.

The invention makes it pointless to perform any subsequent impregnation.

For application purposes, the composition may be dispersed in a solvent that can be caused to evaporate, or it can be put into solution.

The resin may begin to cross-link while it is being applied. Nevertheless, application conditions can easily be adjusted to limit the degree of resin cross-linking, e.g. to less than 20% to 25%.

The cross-linking that leads to bonding is caused to take place by heating directly, or by applying an electric current in an electric wire, e.g. in coil applications, and/or by applying radiation of the ultraviolet type.

The type of treatment, the duration of the treatment, and where appropriate, the heating temperature are selected as a function of the settable resin.

Other characteristics and advantages of the present invention appear from the following description of examples given by way of non-limiting illustration.

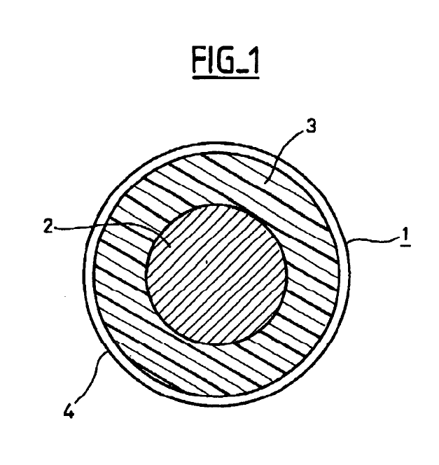

FIG. 1 is a cross-section view of an electrical conductor of the invention suitable for use as an enameled magnet wire in a preferred embodiment of the invention.

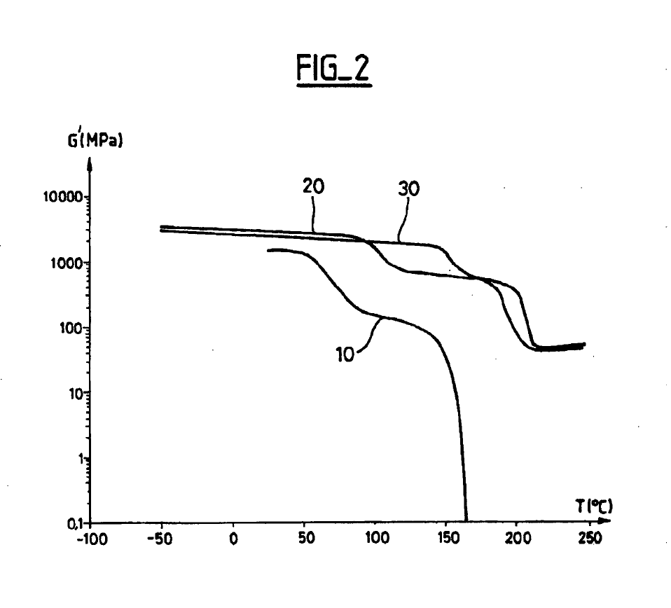

FIG. 2 shows how the storage modulus of the bonding layers varies as a function of temperature.

The enameled magnet wire 1 comprises an electrical conductor 2, e.g. made of copper, coated in an insulating layer 3 of conventional enameled varnish, itself coated in a layer 4 of a composition of the invention as described below in Example No. 1. The layer 4 is to form a bonding layer.

### EXAMPLE NO. 1

In this first example, the composition is a uniform mixture having the following formulation:
30% to 60% parts by weight of thermoplastic polymer preferably having a high glass transition temperature and/or a high melting temperature, and preferably 40% polyphenylene oxide (PPO) also known as polyphenylene ether, e.g. the product sold under the name Noryl PPO 820 by the supplier General Electric Plastics;
40% to 70% parts by weight of a mixture containing a settable resin, e.g. a thermosettable resin, and preferably:
   41.8% of a thermosettable resin such as diglycidyl ether of bisphenol-A (DGEBA), e.g. the product sold under the name D.E.R. 330 by the supplier Dow Chemical; and
   18.2% of a curing compound that reacts chemically with the thermosettable resin, such as an amine, e.g. 4,4′-methylenebis-(2,6-diethyl)benzenamine, such as the product sold under the name Lonzacure MDEA by the supplier Lonza.

The selected polyphenylene ether is an amorphous polymer which, when pure, presents a glass transition temperature of 210° C.

The manufacture of an enameled wire coil using the magnet wire shown in FIG. 1 is simple, fast, and clean, and can be performed by users themselves.

After winding, the enameled wire is subjected to heat treatment, i.e. heated to 200° C. in an oven for at least 30 minutes and preferably for 1 hour in order to increase the degree to which the thermosettable resin is cross-linked.

After being coiled and treated, the wire includes a self-bonding layer that withstands high temperatures and is therefore suitable for all types of electric motors and electromagnetic deflector coils for televisions.

FIG. 2 plots three curves 10, 20, and 30 showing how the storage modulus G′ (in megapascals (MPa)) varies as a function of temperature (in ° C.) for three bonding layers on enameled conductor wire.

A first curve 10 shows the storage modulus of a conventional self-bonding layer “A” of a standard polyamide. A second curve 20 shows the storage modulus of a self-bonding layer “B” obtained from the composition of the invention as described in Example No. 1, and after being subjected to heat treatment at 20° C. for 30 minutes. A third curve 30 shows the storage modulus of a self-bonding layer “C′ obtained from the composition of the invention as described above in Example No. 1, and after being subjected to heat treatment at 200° C. for 60 minutes.

The way in which the storage modulus varies as a function of temperature provides information about the bonding capacity of the layer and its ability to withstand high temperatures. The storage modulus G′ is obtained by dynamic mechanical analysis.

With reference to the first curve 10, it can be seen that at ambient temperature, the storage modulus is greater than 1000 MPa: the layer A is rigid. Between about 50° C. and about 110° C., there can be seen a first drop in this modulus to about 100 MPa: this is the glass transition phase, the layer A softens and presents molecular mobility. From about 150° C. a second and sudden drop occurs in the modulus: this is the melting stage, and the layer A no longer presents any cohesion and becomes liquid.

The storage modulus represented by the second curve 20 is greater than 2000 MPa over a wide range of temperatures from about −50° C. to about 90° C.: the layer B is very rigid. Between 90° C. and 110° C., a first drop is observed in this modulus down to a value of about 600 MPa: the layer B nevertheless remains relatively rigid. After a broad level in which thermomechanical properties are stable, there is a second drop in the modulus starting from about 180° C. Above 200° C., the layer B retains a certain amount of rigidity.

The storage modulus shown in the third curve 30 is greater than 2000 MPa over a broad range of temperatures going from −50° C. to 150° C.: the layer C is very rigid.

The selected heating temperature and heating duration depend on the selected mixture and on the looked-for specifications.

Three other examples of compositions in accordance with the invention are given below.

### EXAMPLE NO. 2

A composition of the invention is initially prepared in a solvent.

750 grams (g) of a solvent, preferably toluene, is loaded into a three-necked Woulff bottle fitted with a stirrer, a cooler, and a temperature probe, and is heated to 60° C. While maintaining the temperature at 60° C., 150 g of thermoplastic polymer such as polyphenylene ether, e.g. the Noryl PPO 820 product described in Example No. 1 is added progressively under stirring by means of a powder funnel. Introduction lasts for 30 minutes. The mixture is stirred continuously until non-dissolved powder particles have disappeared.

Using a dropping funnel, 147 g of thermosettable resin such as diglycidyl ether of bisphenol-A (DGEBA), e.g. the product D.E.R. 330 described above in Example No. 1, is added progressively over 20 minutes under mechanical stirring while maintaining the medium at 60° C. The mixture continues to be stirred for 10 minutes, and then a powder funnel is used to introduce therein, progressively over 15 minutes, 78 g of a curing compound that reacts chemically with the thermosettable resin, e.g. amine 4,4′-methylenebis-(3-chloro-2,6-diethyl)benzenamine, such as the product Lonzacure MCDEA from the supplier Lonza.

The mixture is maintained at 60° C. under mechanical stirring for 10 minutes prior to being placed in a crystallizing dish.

Thereafter, the toluene is evaporated under a vacuum. The yield of mixture is close to 100%.

### EXAMPLE NO. 3

Initially a composition of the invention is prepared in a solvent.

750 g of toluene is loaded into a Woulff bottle fitted with a stirrer, a cooler, and a temperature probe, and is then heated to 60° C. While maintaining a temperature at 60° C., 150 g of thermoplastic polymer such as polyphenylene ether, e.g. the product Noryl PPO 820 described above in Example No. 1 is added progressively using a powder funnel and while maintaining stirring. The duration of introduction is 30 minutes. The mixture is stirred continuously until non-dissolved powder particles have disappeared.

Using a dropping funnel, 100 g of photocurable resin such as diglycidyl ether of bisphenol-A (DGEBA), e.g. the product D.E.R. 330 (Dow Chemical) is added progressively over 15 minutes under mechanical stirring and while maintaining the medium at 60° C. The mixture continues to be stirred for 10 minutes and then 2 g of a photoinitiator, e.g. the product Rhodorsil Photoinitiator 2074 from the supplier Rhodia is introduced progressively over 5 minutes.

The mixture is maintained at 60° C. under mechanical stirring for 10 minutes prior to being placed in a crystallizing dish.

Thereafter the toluene is evaporated under a vacuum. The yield of mixture is close to 100%.

### EXAMPLE NO. 4

A mixture is introduced via a constant weight feeder into the feed hopper of an extruder head having two co-rotating screws and fitted with nine successive heating zones at the following temperatures respectively 60° C., 160° C., 190° C., 190° C., 180° C., 180° C., 180° C., 180° C., and 180° C. between the first zone and the ninth zone, and also having two feed zones and two degassing wells. The mixture comprises:
1800 g of a thermoplastic polymer such as polyphenylene ether, e.g. Noryl PPO 820 in powder form; and
398 g of a 4,4′-methylenebis-(2,6-diethyl)benzenamine such as the Lonzacure MDEA product described above in Example No. 1, in powder form, at a rate of 20 grams per minute (g/min).

Simultaneously, 802 g of thermosettable resin such as diglycidyl ether of bisphenol-A (DGEBA), e.g. the resin D.E.R. 330 is introduced progressively at 80° C. and at a rate of 13.3 g/min into the second zone using a gear pump.

The die is a rod extruder die enabling regular granules to be obtained.

### Tests

Materials as obtained by implementing the above Examples 2 and 4 have been subjected to heat treatment serving to adjust their mechanical properties.

The modulus of elasticity G′ of the materials was determined by dual cantilever mode mechanical dynamic analysis using the DMA 2980 appliance (from TA Instruments) with stress being applied at a frequency of 1 hertz (Hz) and at an amplitude of 100 micrometers (μm) over a temperature range from −50° C. to +250° C., while varying temperature at a rate of 3° C./min.

A standard prior art polyamide was used as a reference material.

The results obtained are summarized in Table 1 below:

TABLE 1

| | | G′ at | G′ at | G′ at |
|---|---|---|---|---|
| | Heat | 25° C. | 100° C. | 150° C. |
| | treatment | (MPa) | (MPa) | (MPa) |
| Example 2 | 60 minutes | 2772 | 636 | 434 |
| | 200° C. | | | |
| | 90 minutes | 2625 | 2017 | 522 |
| | 200° C. | | | |
| | 120 minutes | 2291 | 1817 | 1474 |
| | 200° C. | | | |
| Example 4 | 30 minutes | 2696 | 1418 | 589 |
| | 200° C. | | | |
| | 60 minutes | 2275 | 1841 | 1190 |
| | 200° C. | | | |
| Standard | — | 848 | 218 | 164 |
| polyamide | | | | |

The storage modulus of the materials of Examples Nos. 2 and 4 is considerably greater both at 25° C. and at 150° C., than for a standard polyamide.

Naturally, the present invention is not limited to the embodiments described above.

The invention applies equally well to power cables and to telecommunications cables for their sheathing and/or insulation layers.

Finally, any means may be replaced by equivalent means without going beyond the ambit of the present invention.

1. An electrical conductor comprising:
a conductor coated in an insulating layer, itself coated in a bonding layer, wherein said bonding layer is obtained from a composition comprising a thermoplastic polymer and a settable resin.

2. An electrical conductor according to claim 1, wherein the settable resin is photocurable or thermosettable.

3. An electrical conductor according to claim 1, wherein the thermoplastic polymer presents a glass transition temperature greater than or equal to 150° C.

4. An electrical conductor according to claim 1, wherein when the thermoplastic polymer is semi-crystalline, the thermoplastic polymer presents a melting temperature greater than or equal to 200° C.

5. An electrical conductor according to claim 1, wherein the thermoplastic polymer is at least partially soluble in the settable resin.

6. An electrical conductor according to claim 1, wherein the thermoplastic polymer is selected from one or more of the following polymers: polystyrenes; polyetheretherketones; polyetherimides;
polyamides; polyolefins and copolymers of polyolefins; polysulfones; polyurethanes; polyesters;
cyclic oligoesters; polyimides and copolymers of polyimides; polyphenylene ethers;
polyphthalamides; vinyl polychlorides; polyacrylics; polymethacrylates; and polycarbonates.

7. An electrical conductor according to claim 1, wherein the settable resin is selected from epoxy resins, vinyl ester resins, unsaturated polyester resins, phenolic resins, alkyl resins, acrylic resins, ester cyanates, and benzoxazines.

8. An electrical conductor according to claim 1, wherein for a thermosettable resin, said composition includes at least one of the following compounds: a curing compound that is chemically reactive with said settable resin, and a curing catalyst.

9. An electrical conductor according to claim 8, wherein the resin is thermosettable and is an epoxy homopolymer and preferably a diglycidyl ether of bisphenol-A, and the setting compound is selected from amine compounds, carboxylic anhydrides, and polyamides.

10. An electrical conductor according to claim 1, wherein said composition contains 30% to 60% parts by weight of polyphenylene oxide and 70% to 40% parts by weight of a mixture containing diglycidyl ether of bisphenol-A and an amine selected from 4,4′-methylenebis-(2,6-diethyl)benzenamine amine and 4,4′-methylenebis-(3-chloro-2,6-diethyl)benzenamine.

11. An electrical conductor according to claim 1, wherein the settable resin is a photocurable resin selected from one of the following resins: acrylate resins; methacrylate resins; epoxy resins; and vinyl ethers.

12. An electrical conductor according to claim 1, wherein for a photocurable resin, the composition includes a photoinitiator.

13. A method of manufacturing an electrical conductor said method comprising the steps of:
coating said electrical conductor with a bonding layer according to claim 1, further comprising the step of applying said composition on said electrical conductor coated in said insulating layer, and applying treatment to cause said settable resin to be cured at least in part.

14. A method according to claim 13, wherein the curing treatment is selected from at least one of the following treatments: heat treatment, ultraviolet type radiation.
